(19) United States
(12) Patent Application Publication
(10) Pub. No.: US 2004/0003025 A1
(43) Pub. Date: Jan. 1, 2004

(54) Remote image-monitoring host and monitoring apparatus

(76) Inventor: Vincent Hao, Taipei (TW)

Correspondence Address: J.C. Patents, Inc., Suite 250, 4 Venture, Irvine, CA, 92618, US

(21) Appl. No.: 10/215,449

(22) Filed: Aug. 9, 2002

(30) Foreign Application Priority Data
Jun. 5, 2002 (TW) 91208320

(51) Int. Cl. G06F 15/16; H04N 7/173

(52) U.S. Cl. 709/201

(57) ABSTRACT

A remote image monitoring host and a monitoring apparatus. The design of the remote image monitoring host is changed, so that instead of using a personal computer to select a certain monitor station for monitoring image, a display such as a television or monitor can be connected to any remote image monitoring host, and a remote control can be used to select a monitoring station of which the image is displayed. Therefore, the remote image monitoring host and the monitoring apparatus can be installed at any monitoring station to conveniently monitor the images in monitoring stations located in various places.

### CROSS-REFERENCE TO RELATED APPLICATION

This application claims the priority benefit of Taiwan application serial no. 91208320, filed Jun. 5, 2002.

### BACKGROUND OF THE INVENTION

1. Field of the Invention

The invention relates in general to monitoring equipment, and more particular, to remote image-monitoring host and monitoring apparatus.

2. Related Art of the Invention

The advancement of electronic technology has allowed for various kinds of information to be processed in digital format with a much more enhanced processing speed by a computer. In addition, the development of network techniques have provided the convenience of sharing information. Currently, the Internet has become a common medium for various kinds of information communication. The distance between individuals has been shortened, and communication is more frequently made.

Security control has continuously developed since the beginning of the computer network. Being restricted by information transmission times, the remote monitor is difficult. Now, because of highly advanced electronic technology and computer networks, to monitor a remote image is very convenient and common. For example, for the broadly and intensively distributed chain convenience shops, remote image monitoring apparatus, which transmits the image of a monitored target throughout the network, provides the owner or the manager with full surveillance.

Further referring to FIG. 1, a conventional remote image monitoring apparatus is shown. The remote image monitoring apparatus includes a first remote image-monitoring host 110 connected to the Internet 120, a second remote image monitoring host 130 and a personal computer 160. The first and second remote image monitoring hosts 110 and 130 are installed at different monitoring places. By connecting to cameras 140 and 150, respectively, the images of a monitored target extracted in different places are then extracted. When the user intends to monitor a remote image from the personal computer 160, a HyperText Transfer Protocol (HTTP) request is sent via an installed-software to request the first or second remote image-monitoring host 110 or 130 to transmit the extracted image back via the Internet. The remote image monitoring is thus achieved.

Obviously, such a method allows the operator familiar with the computer software and hardware to easily achieve monitoring. It is not necessarily easy for a user who is not familiar with computer operation. Further, as the remote image-monitoring host has to be installed in every surveillance place for transmitting the extracted image therefrom, while a personal computer or software is not installed in each place, installation of an additional personal computer is required before monitoring the remote image each time, so that the cost is increased. The former increases the fabrication cost, while the latter, though save the cost, cause inconvenience for application.

### SUMMARY OF THE INVENTION

The present invention provides a remote image monitoring host and a monitoring apparatus, by which channel selection operation is easily performed by a remote control. The display connected to the remote image-monitoring host is used to monitor the remote image without the installation of an additional personal computer and software. The application is thus very simple and convenient

In addition to the remote image-monitoring host, the remote image monitoring apparatus further comprises a remote control and a display, so that a monitoring command can be easily output via the remote control. The monitoring command is then converted into a HTTP request to be transmitted in a network. A remote image in response to the HTTP request is then received by the network and displayed in the display.

The remote image-monitoring host includes an infrared receiver, a display interface unit, an HTTP client unit and an image decompression unit. The infrared receiver is used to receive the monitoring command output by the remote control. The display interface unit is coupled to the infrared receiver to provide a display interface and the monitoring command to the display. The HTTP client unit is coupled to the display interface unit to convert the monitoring command into an HTTP request and transmit the monitoring command via a communication medium. The compressed remote image in response to the HTTP request is then received by the communication medium. The image decompression unit is coupled to the HTTP client unit and the display interface unit, so that the compressed remote image is decompressed, and the remote image is displayed in the display while being transmitted via the display interface unit.

In addition to monitoring the remote image, in order to simultaneously monitor the local image, the remote image-monitoring host may further comprise an image extraction unit, an image compression unit and a web server unit. The image extraction unit is connected to a camera, so as to extract the local image of a local monitored target. The web server unit is coupled to the image compression unit to receive the remote HTTP request, and to transmit the compressed local image to respond to the remote HTTP request.

In one embodiment of the present invention, the display interface includes an audio video (AV) interface connected to a television or a video graphic array (VGA) connected to a monitor. The communication medium includes uses Ethernet connecting cable connecting to the Ethernet or a serial port connecting cable connecting to a modem, so as to connect to the Internet. The operation includes outputting a monitor channel setting command by a remote control for channel setting and the channel table corresponding to the remote monitoring station. The channel to be monitored is then selected by the channel selecting command.

It is known from the above that while operating the remote image monitoring host and monitoring apparatus provided by the present invention, an additional personal computer is not required, while the operation is altered to using the remote control to select the monitored channel only. It is thus very simple and convenient.

### BRIEF DESCRIPTION OF THE DRAWINGS

These, as well as other features of the present invention, will become more apparent upon reference to the drawings wherein:

FIG. 1 shows the application of a conventional remote image monitoring apparatus;

FIG. 2 shows the application of a remote image monitoring apparatus provided in one embodiment of the present invention;

FIG. 3 is a block diagram of a remote image extraction circuit in one embodiment of the present invention;

FIG. 4 shows a block diagram of a remote image monitoring apparatus provided in one embodiment of the present invention; and

FIG. 5 is a block diagram of the remote image monitoring apparatus provided in another embodiment of the present invention.

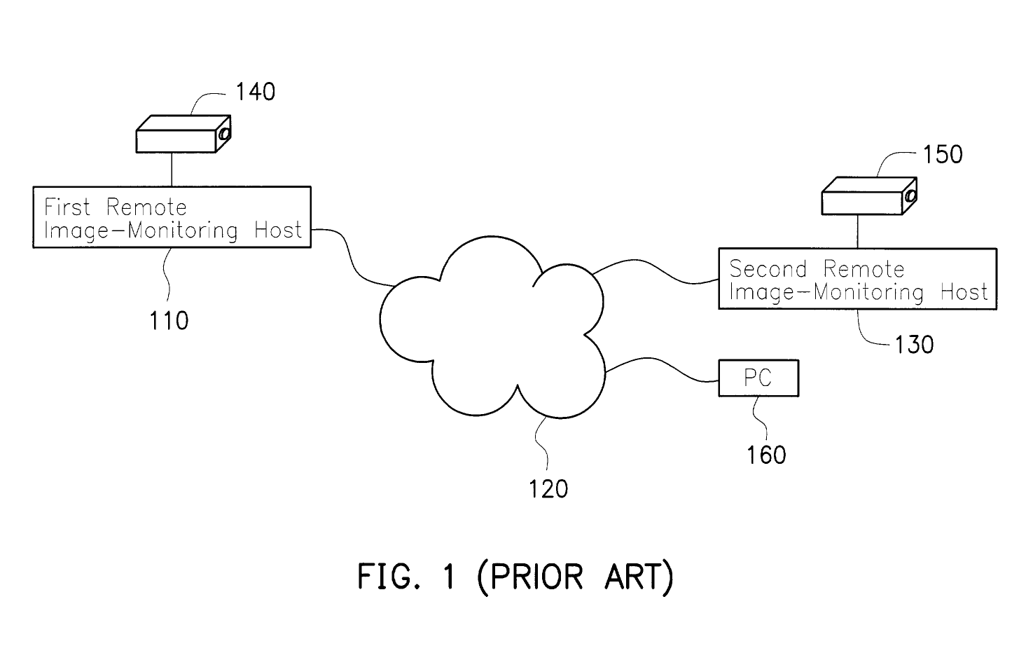

### DETAILED DESCRIPTION OF THE PREFERRED EMBODIMENT

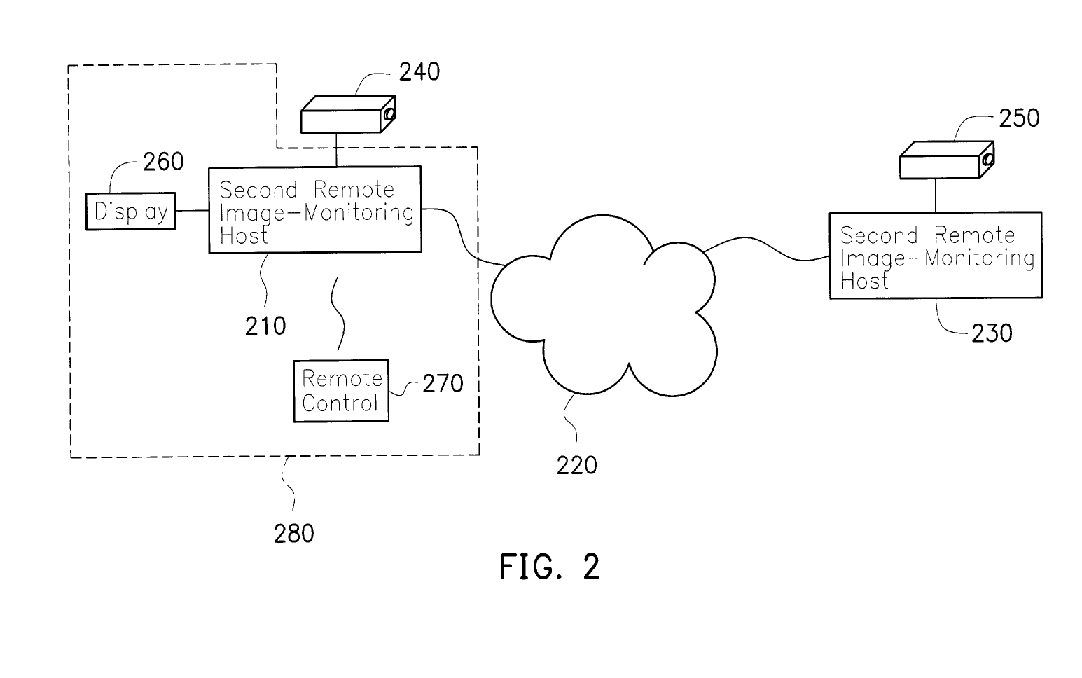

Referring to FIG. 2, the application of a remote image monitoring apparatus is shown. The application includes a third remote image-monitoring host 210 and a fourth remote image-monitoring host 230 connected to a network 220. The third and fourth remote image-monitoring hosts 210 and 230 are installed at different monitoring locations and connected to cameras 240 and 250 to extract local image and remote image, respectively. The image to be displayed is selected by the remote control 270. Therefore, the third remote image-monitoring host 210, the display 260 and the remote control 270 are combined as the remote image-monitoring apparatus 280 provided by the present invention. It is appreciated that the embodiment of connecting two remote image-monitoring hosts 210 and 230 in the remote image-monitoring apparatus 280 can be expanded according to specific requirements, while the number of cameras connected to each remote image-monitoring host can also be expanded. In addition, the display 260 can select the full-screen to display the image at one place, or partition the screen to display multiple images.

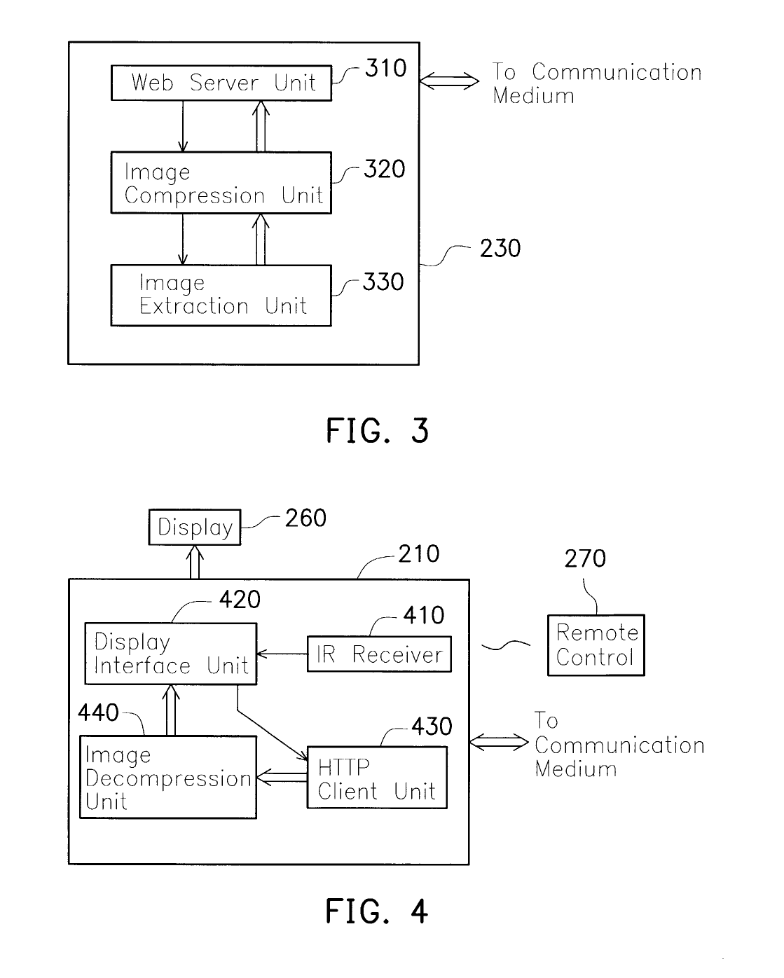

Further referring to FIG. 2, a simple application is illustrated as an example. The fourth remote image-monitoring host 230 is used to extract a remote image of a remote monitored object via a camera 250. A network 220 of the Internet is used to transmit the remote image to the third remote image-monitoring host 210. The remote control 270 is use to selectively display the remote image on the display 260. The fourth remote image-monitoring host 230 of such application further comprises at least one remote image extraction circuit. The circuit block diagram of the remote image extraction circuit is shown in FIG. 3, while the block diagram of the third remote image-monitoring host 210 is shown in FIG. 4.

As the fourth remote image-monitoring host 230 is to extract the remote image, the block diagram as shown in FIG. 3 includes the image extraction unit 330, the image compression unit 320 and the web server unit 310. The image extraction unit 330 is connected to the camera to extract the remote image of the remotely monitored target. However, the remote image is compressed via the image compression unit 320. When the web server unit 310 receives a HTTP request via the communication medium, the compressed remote image is output by a communication medium in response to a HTTP request.

The block diagram of the remote image-monitoring host 210 at the receiving terminal is shown and comprises an infrared receiver 410, a display unit interface 420, an HTTP client unit 430 and an image decompression unit 440. When the infrared receiver 410 receives a monitoring command output from the remote control 270, the on screen display (OSD) function of the display interface unit 420 is transmitted via the display interface and displayed on the display 260. The display 260 includes a television or monitor. The display interface connecting to the display 260 uses an audio video (AV) interface to connect the television, or a video graphics array (VGA) interface to connect to the monitor. The monitor command includes a monitor channel setting command to set up channel and the channel table corresponding to the remote monitoring station, or a monitoring channel selecting command to select among the monitoring channels. When the received monitoring command is a monitoring channel selecting command, the HTTP client unit 430 converts the monitoring channel selecting command into an HTTP request which is then transmitted by a communication medium. Such communication medium can be connected to the Ethernet via an Ethernet cable, or a connected to the Internet via a serial port cable. When the fourth remote image-monitoring host 230 responds the HTTP request with a compressed remote image, the HTTP client unit 430 transmits the compressed remote image to the image decompression unit 440. Being decompressed by the image decompressed unit 440, the remote image is recovered transmitted via the interface unit 420 for display by the display 260.

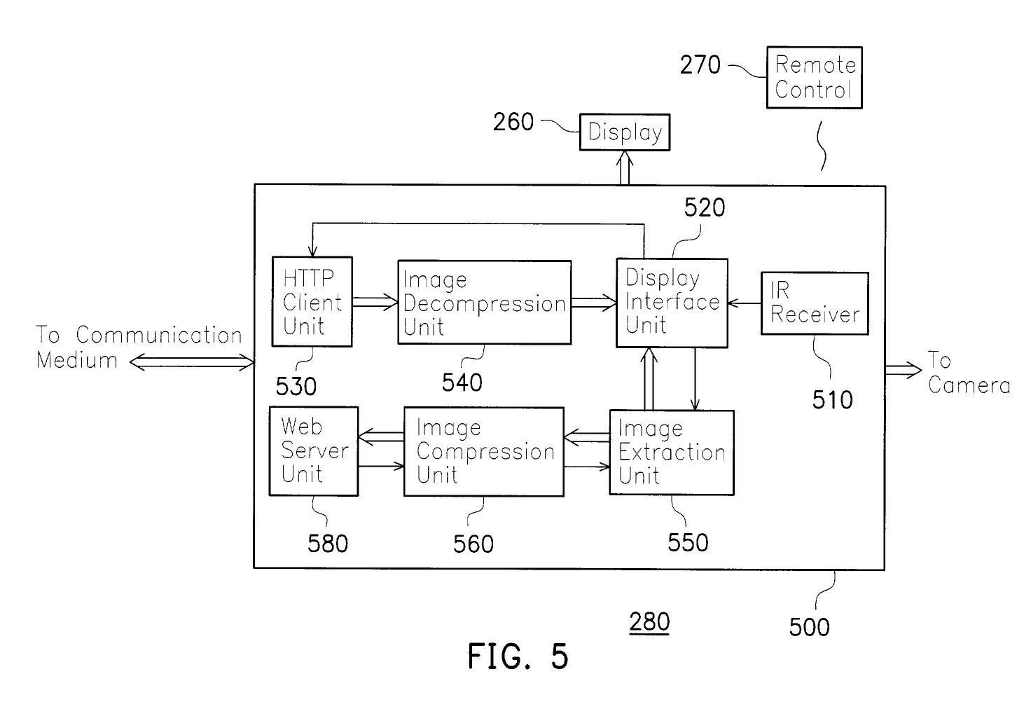

Referring to FIG. 5, a block diagram of a remote image-monitoring host in another embodiment of the present invention is shown. In addition to the infrared receiver 510, the display interface unit 520, the HTTP client unit 530 and the image decompression unit 540, the remote image-monitoring host 500 further comprises an image extraction unit 550 with similar function as shown in FIG. 3, an image compression unit 560, and a web server unit 580. In addition to receiving the monitoring command output from the remote control 270 as shown in FIG. 4, the monitoring command is converted into an HTTP request output by the communication medium. The remote image corresponding to the HTTP request is then received by the communication medium and displayed in the display 260. Similar to FIG. 3, the monitored local image is extractable and transmitted to and displayed in the remote monitoring station after being compressed. The remote control 270 can further be used to select the local image of the locally monitored target by the channel setting command and the channel select command thereof.

It is known from the above description that the remote image-monitoring host 500 can be applied to the third and fourth remote image-monitoring host 210 and 230 as shown in FIG. 2, or even to the remote image-monitoring hosts (not shown) distributed in various locations connected to the network 220. Therefore, the user in any monitoring station can easily operate the remote control 270 to select the monitoring channel of which the image is displayed. Therefore, the present invention comprises the following advantages:

1. Installation of an additional personal computer and software, or another portable personal computer, is not required, while the image of any monitoring station can be selectively monitored conveniently, and the cost is reduced.

2. The operation interface of monitoring channels is similar to selection of television channels, such that the operation is simple and convenient.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A remote image-monitoring host, comprising:
an infrared receiver, to receive a monitoring command output from a remote control;
a display interface unit, coupled to the infrared receiver to provide connection of a display interface of a display and transmission of the monitoring command;
an HTTP client unit, coupled to the display interface unit to convert the monitoring command into a local HTTP request via a communication medium, and to receive a compressed remote image corresponding to the local HTTP request by the communication medium; and
an image decompression unit, coupled to the HTTP client unit and the display interface unit to recover the compressed remote image, and to transmit the remote image via the interface unit and display the remote image on the display.

2. The remote image-monitoring host according to claim 1, further comprising:
an image extraction unit, connected to a camera to extract a local image of a locally monitored target;
an image compression unit, coupled to the image extraction unit to receive and compress the local image; and
a web server unit, coupled to the image compression unit to receive a remote HTTP request via the communication medium, and to transmit the compressed local image to respond the remote HTTP request.

3. The remote image-monitoring host according to claim 1, wherein the display interface includes an audio video interface.

4. The remote image-monitoring host according to claim 1, wherein the display interface includes a video graphics array interface.

5. The remote image-monitoring host according to claim 1, wherein the communication medium includes an Ethernet connecting cable.

6. The remote image-monitoring host according to claim 1, wherein the communication medium includes a serial port connecting cable.

7. The remote image-monitoring host according to claim 1, wherein the monitoring command includes a monitoring channel selecting command.

8. The remote image-monitoring host according to claim 1, wherein the monitoring command includes a monitoring channel setting command.

9. A remote image-monitoring apparatus, comprising:
a remote control, to output a monitoring command;
a display, to display an image of a monitored target; and
a remote image-monitoring host, coupled to the display to receive the monitoring command, to convert the monitoring into a local HTTP request transmitted via a network, and to display a remote image in response with the local HTTP request on a display.

10. The remote image-monitoring apparatus according to claim 9, wherein the remote image-monitoring host comprises:
an infrared receiver, to receive the monitoring command;
a display interface unit, coupled to the infrared receiver to provide a display interface connected to the display and to transmit the monitoring command;
a HTTP client unit, coupled to the display interface unit, to convert the monitoring command into local HTTP request transmitted the network, and to receive the compressed remote image in response with the local HTTP request; and
an image decompression unit, coupled to the HTTP client unit and the display interface unit to recover the compressed remote image, and to display the remote image transmitted by the display interface unit on the display.

11. The remote image-monitoring apparatus according to claim 10, wherein the remote image-monitoring host further comprises:
an image extraction unit, connected to a camera to extract a local image of a local monitored target;
an image compression unit, coupled to the image extraction unit to receive and compress the local image; and
a web server unit, coupled to the image compression unit to receive a remote HTTP request via the communication medium, and to transmit the compressed local image to respond the remote HTTP request.

12. The remote image-monitoring apparatus according to claim 9, wherein the display includes a television.

13. The remote image-monitoring apparatus according to claim 9, wherein the display includes a monitor.

14. The remote image-monitoring apparatus according to claim 9, wherein the network includes the Internet.

15. The remote image-monitoring apparatus according to claim 9, wherein the monitoring command includes a monitoring channel selecting command.

16. The remote image-monitoring apparatus according to claim 9, wherein the monitoring command includes a monitoring channel setting command.
